(19) United States
(12) Patent Application Publication
(10) Pub. No.: US 2005/0000887 A1
(43) Pub. Date: Jan. 6, 2005

(54) Process for manufacturing a sector-shaped filter element and filter element

(76) Inventors: Peter Scheucher, Kumberg (AT); Johann Rosler, Graz (AT); Robert Vidonye, Hart b. Graz (AT)

Correspondence Address: ALIX YALE & RISTAS LLP, 750 MAIN STREET, SUITE 1400, HARTFORD, CT, 06103, US

(21) Appl. No.: 10/861,680

(22) Filed: Jun. 4, 2004

(30) Foreign Application Priority Data
Jun. 4, 2003 (AT) A 866/2003

(51) Int. Cl. B01D 27/06

(52) U.S. Cl. 210/486; 210/493.1; 264/45.1

(57) ABSTRACT

A process for manufacturing a sector-shaped filter element for a disc filter from a pre-corrugated sheet of metallic material, where the sheet is stretched, at least at one face end. A sector-shaped filter element produced by this method has one shorter face end and one longer face end, with the ribs of the corrugated structure radiating outwards from the shorter face end to the longer face end.

### BACKGROUND OF THE INVENTION

The invention relates to a process for manufacturing a sector-shaped filter element for a disc filter from a pre-corrugated sheet of metallic material, preferably stainless steel. In addition, the invention relates to a sector-shaped filter element for a disc filter made from a corrugated sheet of metallic material, preferably stainless steel, with one shorter and one longer face end, with ribs of the corrugated structure running from one face end to the other, as well as a device for manufacturing a sector-shaped filter element of this kind.

Disc filters consisting of sector-shaped filter elements are known from DE-A42 18 217, for example, and used in paper-making to filter water out of a pulp mixture. If the sector-shaped filter elements are made of corrugated sheet, as is the case in DE-A-42 18 217, the ribs run parallel to one another, which creates various structural and functional disadvantages. Thus, sector-shaped filter elements are also known which are made up of plates on which ribs are mounted, radiating from the inner edge outwards, as is shown in U.S. Pat. No. 3,471,026. This type of filter element is very heavy and expensive to manufacture.

### SUMMARY OF THE INVENTION

The invention thus has the object of providing a sector-shaped filter element of this type with a simple structure, as well as defining a process and a device with which a filter element of this kind can be manufactured simply and at low cost.

In this filter element, all of the channels between the ribs of the corrugated structure lead to the shorter, inner face end, making it possible to extract the filtered water easily by suction at this central, inner area.

If, in a preferred embodiment of the invention, the ribs adjacent to the longitudinal edges of the filter element run parallel to the longitudinal edges of the segment, the corrugated sheet can then be secured easily in a frame that is needed to stabilize the filter element and to connect adjoining filter elements to one another.

The process according to the invention for manufacturing a sector-shaped filter element for a disc filter and made from a pre-corrugated sheet of a metallic material, preferably stainless steel, is characterized by the sheet being stretched, at least at one face end.

With this process, a sector-shaped filter element according to the invention can be made from a basic element that is relatively simple and inexpensive to manufacture, namely a pre-corrugated metal sheet with ribs originally running parallel to one another.

In order to implement this process, the invention suggests a device that is characterized by clamping jaws for the longitudinal edges of the filter element and which has a drive to pull the clamping jaws apart, at least at one face end of the filter element.

When this happens, the pre-corrugated sheet is stretched, at least at one face end, which automatically creates the final shape of the filter element with the ribs radiating outwards from the shorter to the longer face end.

The process according to the invention allows for the sheet to begin more or less flat and be pre-shaped into corrugations before being stretched, i.e. the corrugated structure of the sheet can be created in a process stage immediately preceding stretching. As an alternative, it would, of course, be possible to purchase the pre-corrugated sheet as a semi-finished product and only perform the process stage of stretching the sheet at least at one face end, according to the patent, in order to manufacture the filter element according to the invention.

### BRIEF DESCRIPTION OF THE DRAWINGS

The present invention may be better understood and its numerous objects and advantages will become apparent to those skilled in the art by reference to the accompanying drawings in which:

FIG. 1 is a horizontal projection of a sector-shaped filter element according to the invention;

FIG. 2 is a sectional view of the filter element taken along line A-B of FIG. 1;

FIG. 3 is a left-hand side view of the filter element of FIG. 1;

FIG. 4 is a sectional view of the filter element taken along line E-F of FIG. 1;

FIG. 5 is a schematic view of a device according to the invention for manufacturing a filter element according to the invention;

FIG. 6 illustrates the corrugated shape of the sheet before stretching;

FIG. 7 shows the corrugated shape of the metal sheet after medium stretching;

FIG. 8 illustrates the corrugated shape of the sheet after maximum stretching; and

FIG. 9 contains a variant with metal screen.

### DETAILED DESCRIPTION OF THE PREFERRED EMBODIMENT

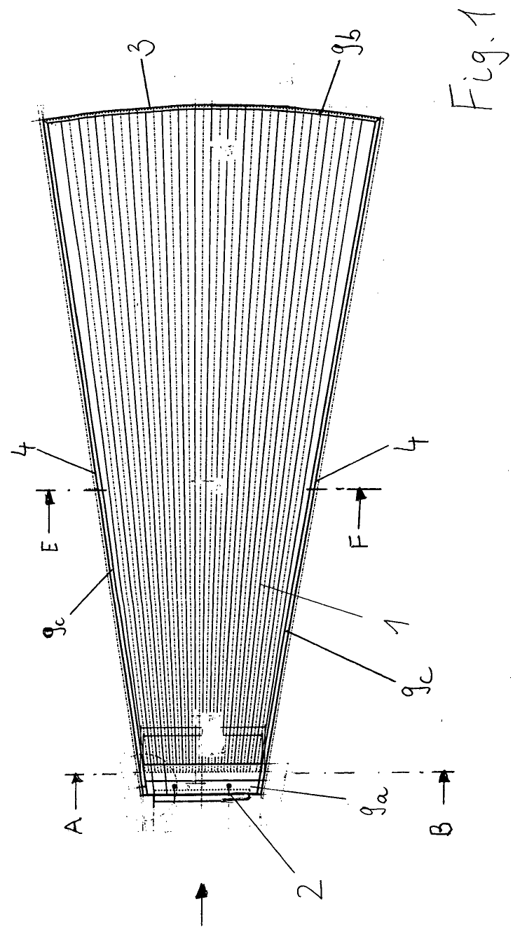

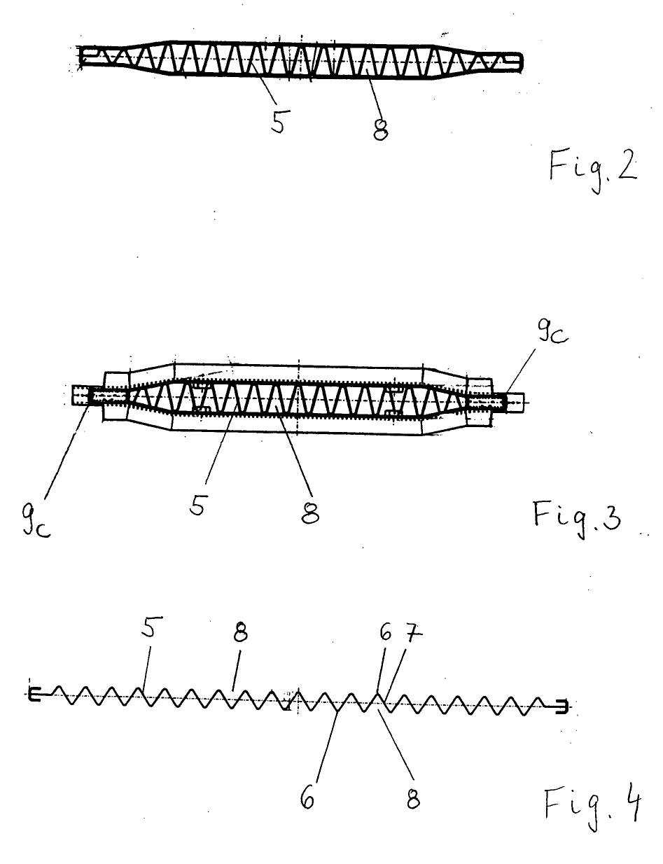

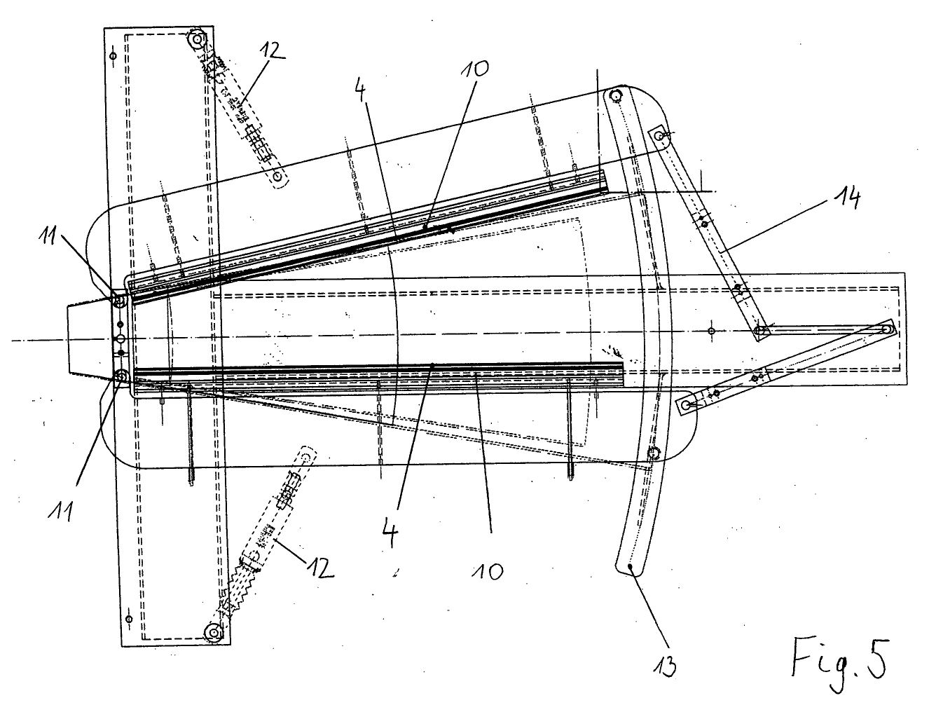

FIGS. 1 to 4 contain a sector-shaped filter element according to the invention, which has a shorter, inner face end 2, a longer, outer face end 3, and two longitudinal edges 4. The filter element according to the invention consists of a sheet 1, which has a largely corrugated shape, where the ribs 5 of the corrugated shape radiate outwards from the inner face end 2 to the outer face end 3. The corrugated shape of the sheet 1 is defined by peaks 6, between which there are largely stretched areas 7. The channels 8 formed between these ribs 5 all lead to the inner face end 2 of the filter element.

The sheet 1 is bordered by a frame consisting of two identical longitudinal parts 9c, as well as a frame section 9a at the inner face end 2 and a frame section 9b at the outer face end 3. Adjoining sector-shaped filter elements are attached to one another by the frame parts 9c, forming a disc that is secured to a shaft—not shown here—in the vicinity of the inner face end 2.

Furthermore, the filter element is enveloped in a filter bag not shown in FIGS. 1 to 4 and which encloses the entire filter element. If a disc filter made up of the filter elements according to the invention rotates through a suspension from which the water is to be removed, the filter elements are subjected to a partial vacuum through the shaft not shown and the inner face end 2 in such a way that water passes through the filter bag into the channels 8 and is extracted radially inwards by suction to the face end 2.

In order to manufacture the filter element according to the invention using the process according to the invention, the device according to the invention and shown in the schematic diagram in FIG. 5 can be used. This consists of clamping jaws 10 which hold the longitudinal edges 4 of the originally rectangular, pre-corrugated sheet. The edges can either be clamped over the entire length of the clamping jaws 10 or at selected discrete points of the clamping jaws 10. The clamping jaws 10 are supported at one end in swivelling bearings at bearing points 11 and pulled apart by means of hydraulic cylinders 12, which engage around the middle section of the clamping jaws 10, until, starting from the basic setting, they reach their final positions as shown by the broken line in FIG. 5 and defined by limit stops 13. Instead of two hydraulic cylinders 12, it would also be possible in an alternative embodiment to provide only one hydraulic cylinder (not shown), mounted on extended lever arms 14 of the clamping jaws 10.

In principle it would also be possible to also provide limit stops similar to the limits stops 13 shown at the end of the clamping jaws 10 facing the inner face end 2 instead of stationary supports for the clamping jaws 10 on bearings 11. This embodiment would allow the sheet 1 to be stretched a little in the vicinity of the inner face end 2 as well.

Since the invention is based on a largely rectangular, pre-corrugated sheet with ribs running parallel to one another, the sheet length, i.e. the overall length of the sheet metal material measured along the contours of the corrugations, is largely the same at both face ends 2 and 3.

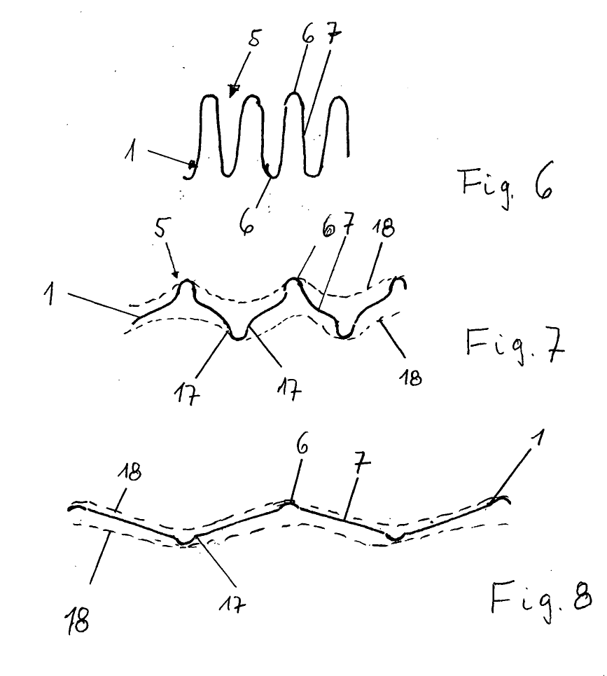

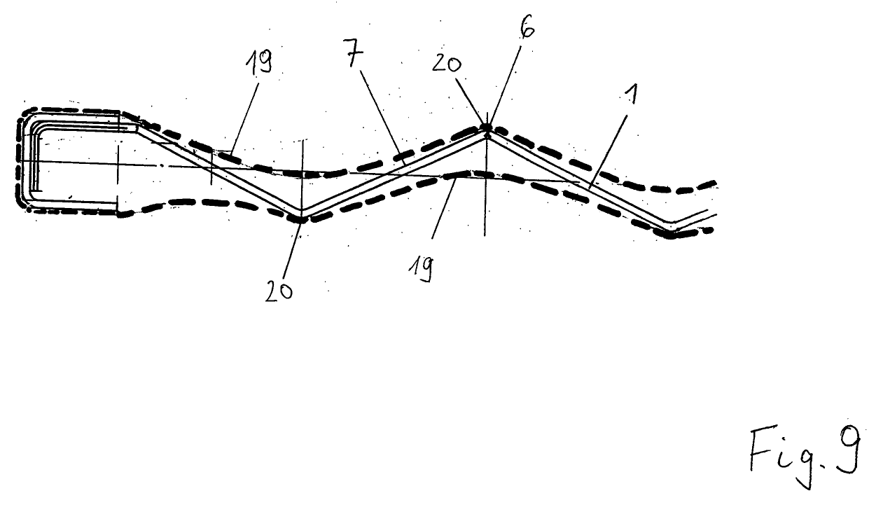

During expansion, the pre-corrugated sheet 1 acts as shown in FIGS. 6 to 8. FIG. 6 illustrates the original corrugated shape, which is also retained on the inner face end 2 if the sheet is not stretched at this face end 2. Between peaks 6, where the sheet 1 has a defined radius of curvature, there are mainly stretched areas 7. During stretching, the sheet 1 deforms at the outer face end 3 first of all, as shown in FIG. 7, to finally attain the stretched shape illustrated in FIG. 8. In this condition, the shape shown in FIG. 7 can be found roughly in the middle section between the face ends 2 and 3. FIGS. 7 and 8 show that S-shaped curved areas 17 are formed between the peaks 6 and the largely stretched areas 7 between them.

As a result, elevations are created that improve the functioning of the filter element according to the invention. As a result of the partial vacuum generated in the channels 8 between ribs 5 when the water is extracted by suction, the filter bag shown as a broken line 18 in FIGS. 7 and 8 is pulled inwards, i.e. towards the sheet wall. If it were to rest on the sheet wall, it would lose its filtering effect. Due to the elevations, however, the filter bag 18 is held largely parallel to the stretched areas 7 with clearance between the two such that the filter bag forms the largest possible filter area, but without resting on the sheet 1.

FIG. 9 shows a variant with a metal screen 19. Here, a pre-shaped metal screen 19 is used, which is shaped similar to the contour 17 of the filter bag in FIG. 7 or 8 and rests on the sheet 1 at the peaks 6. The metal screen 19 is secured preferably to the edges of the frame only, by welding, gluing, clamping, or similar. Due to this corrugated shape of the metal screen 19, the screen surface and thus, the dewatering surface is enlarged by up to 25%. As a result, the dewatering capacity of the disc filter increases accordingly. Since the edges 20 of the metal screen 19 are retained by form closure on the peaks 6 of the corrugated sheet 1, the screen 19 is prevented from sliding and thus becoming worn. The depth of the corrugating can be used to influence the volume of the sector if the supporting structure is the same and thus, the volume of the sector can be adjusted at various operating ranges of the disc filter. If the volume is smaller, this also results in less re-wetting of the filter cake that forms.

The embodiment with a metal screen 19 can also be used without a filter bag.

In an alternative embodiment, however, the invention may also have one perforated plate each on the large area of the filter element facing the observer, as shown in FIG. 1, and on the large area opposite this, which prevent the filter bag being drawn inwards into the channels 8 or replace the filter bag entirely.

While preferred embodiments have been shown and described, various modifications and substitutions may be made thereto without departing from the spirit and scope of the invention. Accordingly, it is to be understood that the present invention has been described by way of illustration and not limitation.

1. A process for manufacturing a sector-shaped filter element for a disc filter from a sheet of metallic material having oppositely disposed first and second face ends and first and second longitudinal sides, comprising the step of stretching the sheet at least at the first face end.

2. The process of claim 1 further comprising the step of shaping the sheet into corrugations before stretching the first face end of the sheet.

3. The process of claim 1 further comprising the step of holding the second face end of the sheet while stretching the first face end of the sheet to prevent stretching at the second face end of the sheet.

4. The process of claim 1 further comprising the step of stretching the second face end of the sheet, the first and second face ends of the sheet being stretched to different widths.

5. The process of claim 1 further comprising the step of holding the longitudinal sides of the sheet with clamping jaws and then stretching the sheet by pulling the clamping jaws apart.

6. The process of claim 1 further comprising the step of mounting a pre-shaped metal screen on the sheet.

7. A sector-shaped filter element for a disc filter, comprising a sheet of a metallic material, having a shorter face end, a longer face end, and a plurality of ribs defining a corrugated structure, the ribs radiating outwards from the shorter face end to the longer face end.

8. The filter element of claim 7 wherein the sheet also has first and second longitudinal edges extending from the shorter face end to the longer face end, the ribs disposed adjacent to the longitudinal edges of the filter element running parallel to the longitudinal edges.

9. The filter element of claim 7 wherein the sheet length being largely the same at both face ends.

10. The filter element of claim 7 wherein the ribs define a plurality of peaks and largely stretched areas disposed between the peaks.

11. The filter element of claim 10 further comprising a pre-shaped metal screen mounted on the sheet.

12. The filter element of claim 11 wherein the metal screen has edges retained by a form closure on the peaks of the ribs.
